(19) United States
(12) Patent Application Publication
(10) Pub. No.: US 2014/0096471 A1
(43) Pub. Date: Apr. 10, 2014

(54) Cabinet door frame assembly and method for assembling a cabinet door frame

(71) Applicant: Sherman Burrows, Round Rock, TX (US)

(72) Inventor: Sherman Burrows, Round Rock, TX (US)

(73) Assignee: Taylorcraft Cabinet Door L.P.

(21) Appl. No.: 13/573,867

(22) Filed: Oct. 10, 2012

(51) Int. Cl. E06B 3/96; B27M 3/00; E06B 3/10

(52) U.S. Cl. CPC E06B 3/96; E06B 3/10; B27M 3/0066
USPC 52/656.4; 144/371; 144/354

(57) ABSTRACT

The preferred embodiment utilizes a key-shaped tenon on a rail that is designed to enter the lock-shaped mortise hole of the stile at the top or bottom of the stile. The key-shaped tenon slides into the top or bottom of the mortise holes of the stiles (i.e. the tenons on the top rail slide into the top of the mortise holes on the top of the left and right stiles while the tenons of the bottom rail slide into the bottom of the mortise holes on the bottom of the left and right stiles). A protrusion on the end of each of the key-shaped tenons of the rails permits it to lodge underneath a lip within each of the lock-shaped mortise holes. This interaction between the protrusion of the tenon and lip of the mortise hole prevents the rail from being removed from or disengaged from the stile in any direction other than the direction of entry. In particular, because the key-shaped tenon is inserted into the lock-shaped mortise hole from the top or bottom of the stile, the rail cannot disengage from the stile in a direction parallel to the rail (i.e. perpendicular to the stile) when the stile and rail are united to form the frame.

### CROSS REFERENCE TO RELATED APPLICATIONS

This non-provisional patent application does not claim priority to any United States provisional patent application or any foreign patent applications.

### FIELD OF THE DISCLOSURE

The disclosures made herein relate generally to the wood cabinet door industry. The invention discussed herein is in the general classification of a wood cabinet door frame and method of assembly of a wood cabinet door frame in which the key-shaped tenons on the rails of the frame interlock with the lock-shaped mortise holes in the stiles of the frame to prevent these components of the frame from disengaging during use.

### BACKGROUND

This section introduces aspects that may be helpful in facilitating a better understanding of the invention. Accordingly, the statements of this section are to be read in this light and are not to be understood as admissions about what is in the prior art or what is not in the prior art.

Kitchen cabinets frequently have wood doors that are comprised of a wood frame and a wood insert panel that is dimensioned to have an appropriate thickness to be inserted into grooves around the inside perimeter of the wood frame (i.e. all four sides of the framing, including the top rail, bottom rail, left stile and right stile, have standard grooves in traditional cabinet doors). Interior and exterior doors, bathroom cabinets, garage doors, furniture and a variety of other items may also utilize wood frames and wood insert panels.

The rails (top and bottom of the frame) tend to disengage from the stiles (sides of the frame) during normal use when traditional mortise and tenon and cope and stick joints are used to unite the rails and stiles of the frame. The disengaging of these components occurs because the tenon on the rail is not sufficiently constrained from movement in most directions when it is inserted into the mortise hole of the stile. The tenon of the rail is often inserted directly into the mortise hole of the stile such that a force pulling directly out from the stile (i.e. a force parallel to the rail) or at virtually any angle to the rail could cause the rail and stile to disengage.

Previous attempts to solve the problem of disengagement of the stiles from the rails during ordinary use have taken many forms. One popular solution involves drilling holes through the stiles and the tenons of the rails to allow pegs to be inserted through the stiles and the tenons of the rails to prevent the rails from pulling away from the stiles. This has obvious drawbacks because it requires the separate drilling of holes in the stiles and the creation of additional components (i.e. the pegs) for the frame. This increases the cost of manufacturing and can create an unsightly appearance due to the presence of the pegs at visible locations of the stiles after the frame is formed.

Hence, it would be beneficial to have a key-shaped tenon on the rails that interlocks with a lock-shaped mortise hole on the stiles to mesh the rail and stiles together. The key-shaped tenon on the rail and the lock-shaped mortise hole of the stile would constrain movement of the rail in relation to the stile in all but one direction—the direction of insertion of the key-shaped tenon into the lock-shaped mortise hole located at the top or bottom of the stile in the preferred embodiment. This arrangement would lock the rail and stile in place to prevent accidental disengagement during normal use.

There is a need in the art for an easy to use, aesthetically pleasing, durable and inexpensive wood cabinet door frame that allows for interlocking of the rails and stiles to prevent accidental disassembly during use.

### SUMMARY OF THE DISCLOSURE

The preferred embodiment utilizes key-shaped tenons on the end of the rails for insertion into corresponding lock-shaped mortise holes in the adjacent stiles.

In the preferred embodiment, the key-shaped tenon is designed to enter the lock-shaped mortise hole of the stile at the top or bottom of the stile. The key-shaped tenon slides into the top or bottom of the mortise holes of the stiles (i.e. the tenons on the top rail slide into the top of the mortise holes on the top of the left and right stiles while the tenons of the bottom rail slide into the bottom of the mortise holes on the bottom of the left and right stiles). A protrusion on the end of each of the key-shaped tenons of the rails permits it to lodge underneath a lip within each of the lock-shaped mortise holes. This interaction between the protrusion of the tenon and lip of the mortise hole prevents the rail from being removed from or disengaged from the stile in any direction other than the direction of entry. In particular, because the key-shaped tenon is inserted into the lock-shaped mortise hole from the top or bottom of the stile, the rail cannot disengage from the stile in a direction parallel to the rail (i.e. perpendicular to the stile) when the stile and rail are united to form the frame.

Certain alternative embodiments may utilize a variety of designs for the lock-shaped mortise holes and key-shaped tenons. Likewise, alternative embodiments may utilize different materials other than wood to form the frame. Many application areas, other than kitchen cabinet doors, may also utilize the embodiments of the invention for forming frames.

Under some applications embodiments of the invention may provide a cabinet door or the like having an interlocking frame.

Under some applications embodiments of the invention may provide a cabinet door frame with key-shaped tenons on the ends of the top and bottom rails that fit into lock-shaped mortise holes on the top and bottom of the left and right stiles.

Under some applications, embodiments of the invention may provide a relatively easy to use cabinet door frame with key-shaped tenons on the ends of the top and bottom rails that fit into lock-shaped mortise holes on the top and bottom of the left and right stiles.

Under some applications, embodiments of the invention may provide a reliable to use cabinet door frame with key-shaped tenons on the ends of the top and bottom rails that fit into lock-shaped mortise holes on the top and bottom of the left and right stiles.

Under some applications, embodiments of the invention may provide an inexpensive to manufacture cabinet door frame with key-shaped tenons on the ends of the top and bottom rails that fit into lock-shaped mortise holes on the top and bottom of the left and right stiles.

Under some applications, embodiments of the invention may provide a durable cabinet door frame with key-shaped tenons on the ends of the top and bottom rails that fit into lock-shaped mortise holes on the top and bottom of the left and right stiles.

Under some applications, embodiments of the invention may provide a strong cabinet door frame with key-shaped tenons on the ends of the top and bottom rails that fit into lock-shaped mortise holes on the top and bottom of the left and right stiles.

Under some applications, embodiments of the invention may provide a cabinet door frame with key-shaped tenons on the ends of the top and bottom rails that fit into lock-shaped mortise holes on the top and bottom of the left and right stiles and that is aesthetically pleasing and suitable for high end cabinet applications.

### BRIEF DESCRIPTION OF THE DRAWINGS

Some embodiments of apparatus and/or methods of the present invention are now described, by way of example only, and with reference to the accompanying drawings, in which:

FIG. 1 depicts a frontal view of a traditional wood door having a wood insert panel within a wood frame.

FIG. 2 depicts a perspective view of one version of a traditional rail and stile of a cabinet door frame prior to them being united.

FIG. 3 depicts an overhead view of the preferred embodiment of a top rail and left stile of a cabinet door frame prior to them being united.

FIG. 4 depicts a side view of the preferred embodiment of a top rail and left stile of a cabinet door frame prior to them being united.

FIG. 5 depicts the preferred methodology of assembling the preferred embodiment of the cabinet door frame.

### DETAILED DESCRIPTION OF THE DRAWINGS

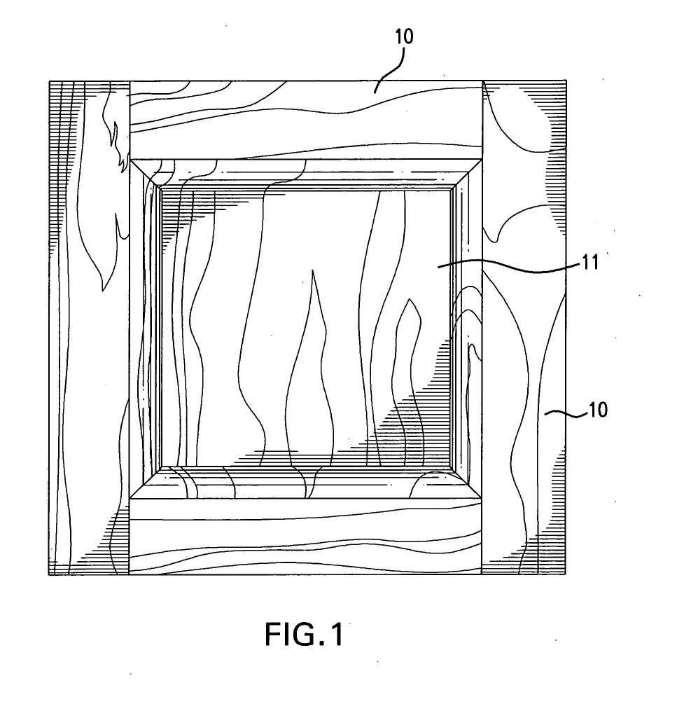

FIG. 1 depicts a frontal view of a traditional wood door having a wood insert panel within a wood frame. The wood door has a frame 10 that surrounds a wood insert panel 11. The frame 10 surrounds the wood insert panel 11 on all sides (i.e. the frame consists of a top rail, a bottom rail, a right stile and a left stile). The wood insert panel 11 and the frame 10 are both substantially rectangular in shape. The wood insert panel 11 is designed to be of such a dimension around the perimeter to securely fit within a groove (not pictured) that runs along the entire inside perimeter of the frame 10 (i.e. a groove is present on the interior of all four sides of the frame 10 to accept the insert panel 11).

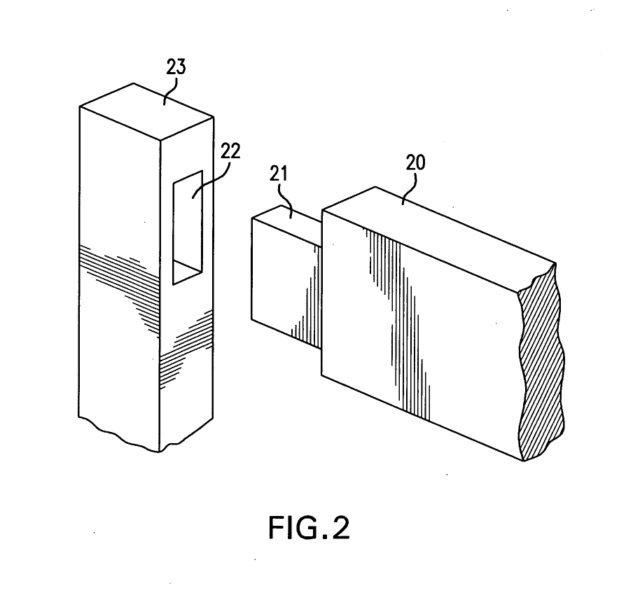

FIG. 2 depicts a perspective view of one version of a traditional rail and stile of a cabinet door frame prior to them being united. The rail 20 and the stile 23 are both substantially rectangular in shape. The rail 20 has a tenon 21 that is shaped to fit within a corresponding mortise hole 22 of the stile 23. This mortise hole 22 and tenon 21 arrangement provides a generally secure fit that substantially secures the rail to the stile.

The top of the rail 20 is generally designed to be flush with the top of the stile 23 when the tenon 21 of the rail 20 is fully inserted into the mortise hole 22 of the stile 23. The mortise hole 22 of the stile 23 may be engineered to provide an interference fit with the tenon 21 of the rail 20. The tenon 21 of the rail 20 is often glued into the mortise hole 22 of the stile 23 to further prevent movement of the rail 20 with respect to the stile 23. Despite this interference fit and bonding, the traditional mortise and tenon arrangement is susceptible to loosening during normal use.

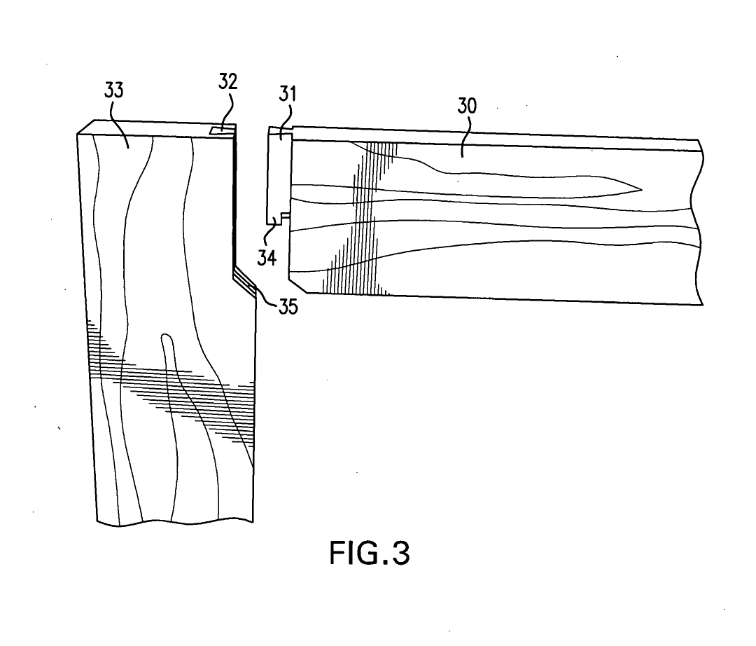

FIG. 3 depicts an overhead view of the preferred embodiment of a top rail and left stile of a cabinet door frame prior to them being united. The top rail 30 and the left stile 33 are both substantially rectangular in shape. The top rail 30 and the left stile 33 have grooves 35 on their inner portions to allow insertion of an insert panel within the rail 30 and stile 33 to form the cabinet door. The rail 30 has a tenon 31 that is shaped to fit within a corresponding mortise hole 32 of the stile 33. The tenon 31 is referred to as key-shaped because it has a protrusion 34 that emanates from the end of the tenon 31. The tenon 31 is inserted into the mortise hole 32 of the stile from the top of the stile 33 such that the protrusion 34 enters the mortise hole 32 first during make-up of the rail 30 and stile 33. The protrusion 34 of the tenon 31 is shaped to fit underneath a lip within the mortise hole 32 to prevent the rail 30 from disengaging from the stile 33 when a force is applied parallel to the rail 30 (i.e. perpendicular to the stile 33). The tenon 31 can only be removed from the mortise hole 32 by applying force in the reverse direction from which it was inserted into the mortise hole 32 (i.e. toward the top of the stile 33).

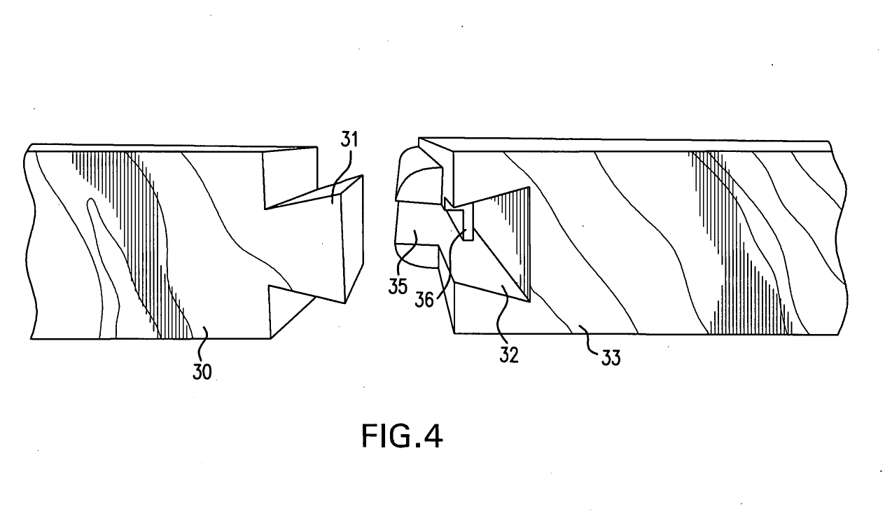

FIG. 4 depicts a side view of the preferred embodiment of a top rail and left stile of a cabinet door frame prior to them being united. The top rail 30 and the left stile 33 have a groove 35 on the inner portions to allow insertion of an insert panel within the rail 30 and stile 33 to form the cabinet door. The rail 30 has a tenon 31 that is shaped to fit within a corresponding mortise hole 32 of the stile 33. The tenon 31 is inserted into the mortise hole 32 of the stile from the top of the stile 33. The protrusion of the tenon 31 is shaped to fit underneath a lip 36 within the mortise hole 32 to prevent the rail 30 from disengaging from the stile 33 when a force is applied parallel to the rail 30 (i.e. perpendicular to the stile 33). The tenon 31 can only be removed from the mortise hole 32 by force exerted in the opposite direction from which it was inserted into the mortise hole 32 (i.e. toward the top of the stile 33).

As would be obvious to one skilled in the art, the right stile has a similar structure to the left stile. As one skilled in the art would further readily recognize, the bottom rail has a similar structure to the top rail. Consequently a rectangular frame could be formed by joining the top and bottom rails to the left and right stiles using the key-shaped tenons at either end of each rail to interlock with the lock-shaped mortise holes at the top and bottom of each stile. As would be obvious to one skilled in the art, the tenons of the bottom rail would be inserted into the mortise holes on the bottom of the stiles. A door could further be formed by inserting an insert panel within grooves on the interior of the stiles and rails.

As a result, a top rail with tenons on opposing ends and a bottom rail with tenons on opposing ends would be inserted into a left stile and a right stile having mortise holes at the top and the bottom that correspond to the shape and dimension of the tenons of the top rail and the bottom rail. The protrusions on the ends of the tenons of the top rail and bottom rail would be inserted first into the mortise holes at the top and bottom of the stiles and a lip within the mortise holes of the stiles would engage the protrusion on the ends of the tenons when the top rail and the bottom rail are connected to the left stile and the right stile.

Certain alternative embodiments may utilize a variety of other designs for the protrusions from the tenons of the rails of the frame and the corresponding lips of the mortise holes of the stiles of the frame. The arrangement of protrusions/keys and lips/locks merely needs to serve the purpose of locking the rail and stile together in every direction except the initial direction of entry of the tenon into the mortise hole at the top of the stile for the tenons of the top rail and at the bottom of the stile for the tenons of the bottom rail. Therefore, the precise shape of these interlocking components is not critical. However, the trapezoidal shape of the preferred embodiment serves to further prevent disengagement of the rail from the stile in a direction parallel to the rail and perpendicular to the stile. Although cabinet doors are traditionally made of wood, a variety of alternative materials may be used to create cabinet door frames or even frames for other types of doors.

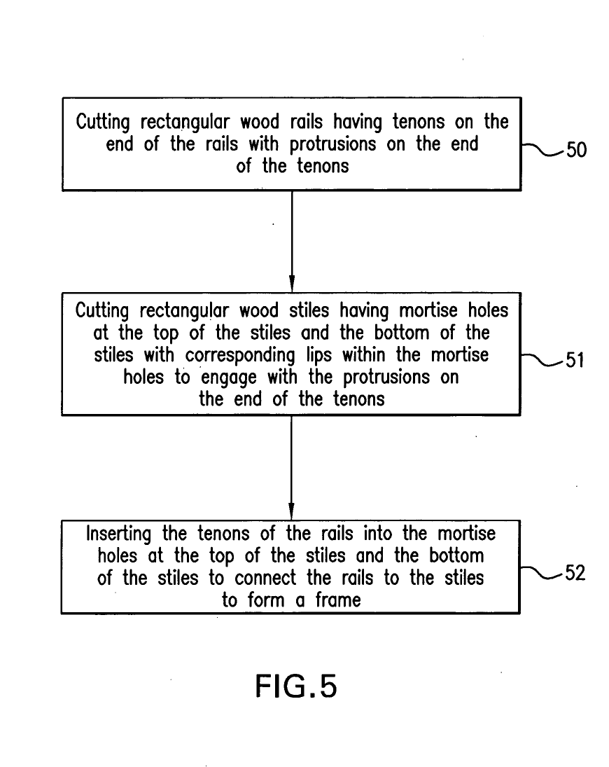

FIG. 5 depicts the preferred methodology of assembling the preferred embodiment of the cabinet door. The method comprises the steps of: cutting rectangular wood rails having tenons on the end of the rails with protrusions on the end of the tenons 50; cutting rectangular wood stiles having mortise holes at the top of the stiles and the bottom of the stiles with corresponding lips within the mortise holes to engage with the protrusions on the end of the tenons 51; inserting the tenons of the rails into the mortise holes at the top of the stiles and the bottom of the stiles to connect the rails to the stiles to form a frame 52.

A person of skill in the art would readily recognize that the order of the steps of the above-described method is not necessarily critical and could be altered without departing from the spirit of the invention.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A door frame comprising:
(a) a top rail with tenons on opposing ends and a bottom rail with tenons on opposing ends;
(b) a left stile and a right stile having mortise holes at the top and the bottom that correspond to the shape and dimension of the tenons of the top rail and the bottom rail;
(c) a protrusion on the ends of the tenons of the top rail and bottom rail for insertion into the mortise holes at the top and bottom of the stiles wherein the protrusion on the ends of the tenons is inserted first into the mortise holes at the top and bottom of the stiles; and
(d) a lip within the mortise holes of the stiles that engages the protrusion on the ends of the tenons when the top rail and the bottom rail are connected to the left stile and the right stile.

2. The door frame of claim 1 wherein the top rail and the bottom rail and the left stile and the right stile are substantially rectangular in shape.

3. The door frame of claim 1 wherein the top rail and the bottom rail and the left stile and the right stile have interior grooves to allow insertion of an insert panel within the top rail and the bottom rail and the left stile and the right stile.

4. The door frame of claim 1 wherein the tenons of the top rail and the bottom rail have a trapezoidal cross-section.

5. The door frame of claim 4 wherein the mortise holes of the left stile and the right stile have a trapezoidal shape to accept the tenons of the top rail and the bottom rail.

6. A door comprising:
(a) a top rail with tenons on opposing ends and a bottom rail with tenons on opposing ends;
(b) a left stile and a right stile having mortise holes at the top and the bottom that corresponds to the shape and dimension of the tenons of the top rail and the bottom rail;
(c) a protrusion on the ends of the tenons of the top rail and bottom rail for insertion into the mortise holes at the top and bottom of the stiles wherein the protrusion on the ends of the tenons is inserted first into the mortise holes at the top and bottom of the stiles;
(d) a lip within the mortise holes of the stiles that engages the protrusion on the ends of the tenons when the top rail and the bottom rail are connected to the left stile and the right stile; and
(e) the top rail and the bottom rail and the left stile and the right stile have grooves on their inner portions to allow insertion of an insert panel within the top rail and the bottom rail and the left stile and the right stile.

7. The door of claim 6 wherein the top rail and the bottom rail and the left stile and the right stile are substantially rectangular in shape.

8. The door of claim 6 wherein the tenons of the top rail and the bottom rail have a trapezoidal cross-section.

9. The door of claim 8 wherein the mortise holes of the left stile and right stile have a trapezoidal shape to accept the tenons of the top rail and the bottom rail.

10. A method of manufacturing a door frame comprising the steps of:
(a) cutting rails having tenons on the end of the rails with protrusions on the end of the tenons; and
(b) cutting rectangular wood stiles having mortise holes at the top of the stiles and the bottom of the stiles with corresponding lips within the mortise holes to engage with the protrusions on the end of the tenons.

11. The method of manufacturing a door frame of claim 10 further comprising the step of:
inserting the tenons of the rails into the mortise holes at the top of the stiles and the bottom of the stiles to connect the rails to the stiles.
